(19) United States
(12) Patent Application Publication
(10) Pub. No.: US 2007/0079031 A1
(43) Pub. Date: Apr. 5, 2007

(54) COMPUTER SYSTEM WITH ENHANCED COMMUNICATION INTERFACE AND COMMUNICATION METHOD THEREOF

(76) Inventor: Kuang-Yung Kung, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,894

(22) Filed: May 23, 2006

(30) Foreign Application Priority Data
Sep. 30, 2005 (CN) 200510100108.9

(51) Int. Cl. G06F 13/38

(52) U.S. Cl. 710/62

(57) ABSTRACT

A computer system includes a host system with an input terminal and an embedded controller. The embedded controller includes a keyboard controller module for controlling the input terminal of the host system, an embedded controller module for receiving standard embedded controller commands from the host system, and an enhanced interface module for receiving extended commands from the host system. The computer system further includes a keyboard controller I/O port configured to support communication between the host system and the keyboard controller module, an embedded controller I/O port configured to support communication between the host system and the embedded controller module, and an enhanced interface I/O port configured to support communication between the host system and the enhanced interface module. A communication method of the embedded controller and a communication method between the computer system and the embedded controller are also disclosed.

### FIELD OF THE INVENTION

The present invention generally relates to computer systems and, more particularly, to a computer system with an embedded controller and an associated communication method thereof.

### DESCRIPTION OF RELATED ART

Embedded controllers were initially used as standard Personal Computer (PC) architecture keyboard controllers. Eventually, these keyboard controllers were modified and added numerous features to standard PC controllers. Embedded controllers are used extensively in mobile computer designs, and are becoming increasingly more prevalent in desktop and server designs, as well.

A computer system 20 illustrated in FIG. 4 includes a host system 10, an embedded controller 12, and an input terminal 14. The host system 10 is connected to the embedded controller 12 to invoke programs embedded in the embedded controller 12. The input terminal 14, such as a touch pad, a keyboard, and a mouse, is connected to the embedded controller 12 to transfer input commands to the embedded controller 14.

Referring to FIG. 5, the embedded controller 12 generally includes a keyboard controller (hereinafter referred as KBC) module 122 and an embedded controller (hereinafter referred as EC) module 144 connected to the host system 10 via a KBC I/O port 102 and an EC I/O port 104, respectively. The KBC I/O port 102 is used for transmitting input commands of the input terminal 14 from the KBC module 122 to the host system 10, while the EC I/O port 104 is used for transmitting standard EC commands from the EC module 124 to the host system 10.

Most computer system suppliers develop specializing programs embedded in the EC modules to implement specializing functions for different applications. These specializing functions, such as temperature monitor, display rotation, display brightness, etc., are called extended commands. In the above-mentioned computer system 20, the extended commands, if any, are transmitted from the EC module 124 to the host system 10 via the EC I/O port 104. Command disputes and interferences usually occur, when both the standard commands and the extended commands are transmitted via the EC I/O port 104 simultaneously.

Either a global lock solution or a critical section solution has been proposed to avoid the command dispute and interference. However, both the global lock solution and the critical section solution involve busy waiting, and reduces efficiency of the entire computer system 20.

Accordingly, a need exists for a communication system with an enhanced communication interface in the industry to address the aforementioned deficiencies and inadequacies.

### SUMMARY OF THE INVENTION

A computer system includes a host system with an input terminal and an embedded controller. The embedded controller includes a keyboard controller module for controlling the input terminal of the host system, an embedded controller module for receiving standard embedded controller commands from the host system, and an enhanced interface module for receiving extended commands from the host system. The computer system further includes a keyboard controller I/O port configured to support communication between the host system and the keyboard controller module, an embedded controller I/O port configured to support communication between the host system and the embedded controller module, and an enhanced interface I/O port configured to support communication between the host system and the enhanced interface module.

A communication method for an embedded controller, the communication method comprising steps of: receiving a command by an enhanced interface module of the embedded controller from a host system via an enhanced I/O port; analyzing the command by the embedded controller; invoking an application program corresponding to the command by the embedded controller; and executing the application program by the embedded controller.

A communication method between a host system and an embedded controller, includes steps of: transmitting an extended command from the host system to the enhanced interface module via the enhanced interface I/O port; and analyzing and executing the extended command by the embedded controller.

Other systems, methods, features, and advantages of the present computer system and the present communication method will be or become apparent to one with skill in the art upon examination of the following drawings and detailed description. It is intended that all such additional systems, methods, features, and advantages be included within this description, be within the scope of the present apparatus, and be protected by the accompanying claims.

### BRIEF DESCRIPTION OF THE DRAWINGS

Many aspects of the present computer system and the present communication method can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is a schematic block diagram illustrating a computer system in accordance with an exemplary embodiment of a computer system with an enhanced interface module;

FIG. 2 is a flow diagram showing a working procedure of the enhanced interface module of FIG. 1;

FIG. 3 is a flow diagram showing a communication procedure of the computer system in accordance with an embodiment of a communication method;

FIG. 4 is a schematic block diagram of a conventional computer system with an embedded controller; and

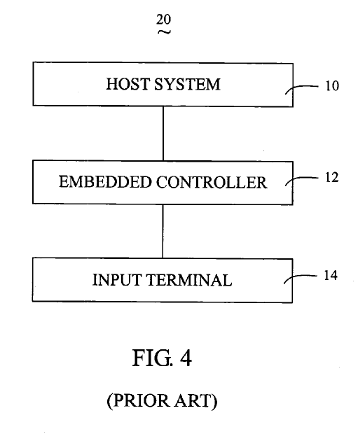

FIG. 5 is a schematic block diagram of the computer system of FIG. 4 showing a more detailed architecture of the embedded controller.

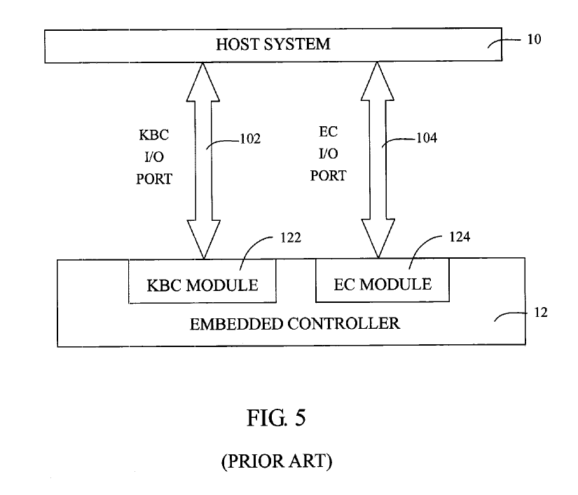

### DETAILED DESCRIPTION OF THE INVENTION

Reference will now be made to the drawings to describe the embodiments of the present computer system and the present communication method, in detail.

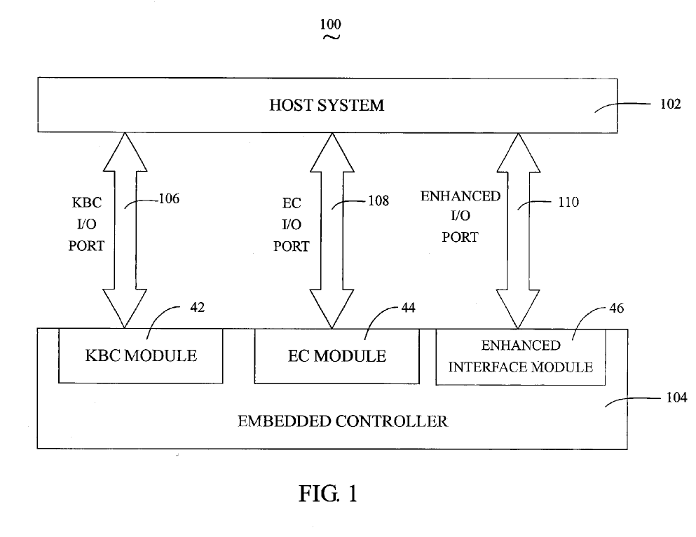

Referring to FIG. 1, a schematic block diagram shows a computer system 100 which includes a host system 102, an embedded controller 104, and communication interfaces between the host system 102 and the embedded controller 104.

The embedded controller 104 includes a KBC module 42 for controlling an input terminal of the host system 102, an EC module 44 for receiving standard EC commands from the host system 102, and an enhanced interface module 46, which may be an actual interface module or a virtual interface module, for receiving extended commands from the host system 102. The KBC module 42, the EC module 44, and the enhanced interface module 46 are connected to the host system 102 respectively via a KBC I/O port 106, an EC I/O port 108, and an enhanced I/O port 110. The KBC I/O port 106 is addressed by 60H/64H, and the EC I/O port 108 is addressed by 62H/66H. The KBC I/O port 106 is used for user command transfers between the KBC module 42 and the host system 102. The EC I/O port 108 is used for transmitting standard EC commands that are advanced configuration and power interface (ACPI) compatible, between the EC module 44 and the host system 102. The enhanced I/O port 110 is used for extended command transfers between the enhanced interface module 46 and the host system 102.

The enhanced I/O port 110 is a private I/O port for the host system 102 to access the enhanced interface module 46. The enhanced I/O port 110 can occupy available but idle ports of the host system 102, for example, ports 381H-383H. Port 381H is used for transferring a high nibble of the embedded controller 104 memory index address, port 382H is used for transferring a low nibble of the embedded controller 104 memory index address, and port 383H is used for inputting/outputting data. In order to avoid potential security risk, the enhanced I/O port 110 is available only in system management mode (SMM). In other cases, the enhanced I/O port 110 is invisible and inaccessible to ensure internal communication between the host system 102 and the embedded controller 104 against any potential risk.

When the extended command is to be sent, the host system 102 unlocks the enhanced I/O port 110 in an interrupt-based mode. Then, the extended command is sent to the enhanced interface module 46 via the enhanced I/O port 110 by the host system 102. The embedded controller 104 determines whether the enhanced interface module 46 receives the extended command by a polling-only solution or an interrupt-based solution. In the polling-only solution, the embedded controller 104 periodically scans the enhanced interface module 46 for extended commands received. In the interrupt-based solution, the enhanced interface module 46 sends an interrupt signal to the embedded controller 104 upon receiving the extended command. The extended command is executed by the embedded controller 104, and feeds back execution results to the host system 102 via the enhanced I/O port 110 after execution.

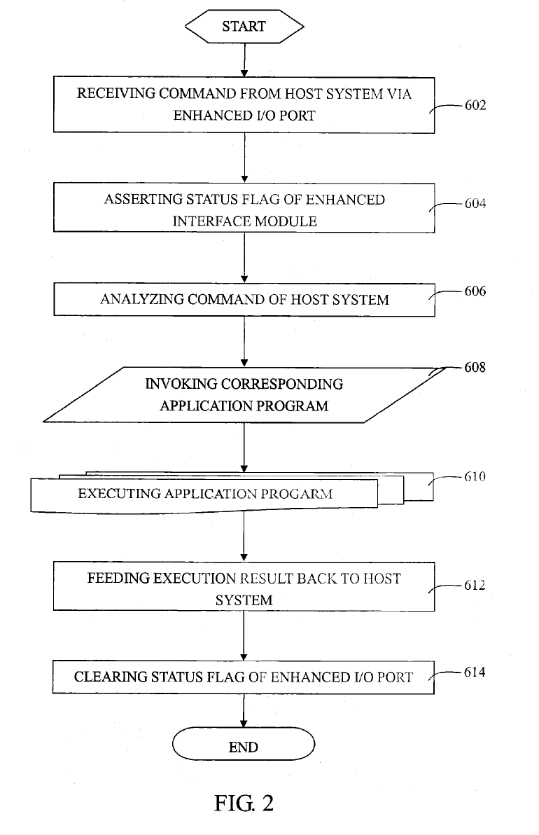

Referring to FIG. 2, a flow diagram shows a working procedure that may be utilized by the enhanced interface module 46. When the enhanced I/O port 110 is unlocked, a general flow of the enhanced interface module 46 after initialization is as follows:

602. Receive a command from the host system 102 via the enhanced I/O port 110.

604. Assert a status flag of the enhanced interface module 46.

606. Analyze the command sent by the host system 102.

608. Invoke an application program corresponding to the command.

610. Execute the application program.

612. Feed the execution result back to the host system 102.

614. Clear the status flag of the enhanced interface module 46.

In step 602, the host system 102 transmits the command to the enhanced interface module 46 via the enhanced I/O port 110, and the enhanced interface module 46 receives the command. When the enhanced interface module 46 receives the command, the status flag of the enhanced interface module 46 is asserted to indicate that the enhanced interface module 46 is “busy” (step 604). The enhanced interface module 46 analyzes the command (step 606) and invokes the application program corresponding to the command (step 608). Then, the enhanced interface module 46 executes the application program (step 610). After execution, the execution result is fed back to the host system 102 via the enhanced I/O port 110 (step 612). Finally, the “busy” status flag of the enhanced interface module 46 is cleared (step 614). The status flag of the enhanced interface module 46 is used for the host system 102 to recognize the status of the enhanced interface module 46. No other commands can be transmitted to the enhanced interface module 46 until the status flag of the enhanced interface module 46 is cleared.

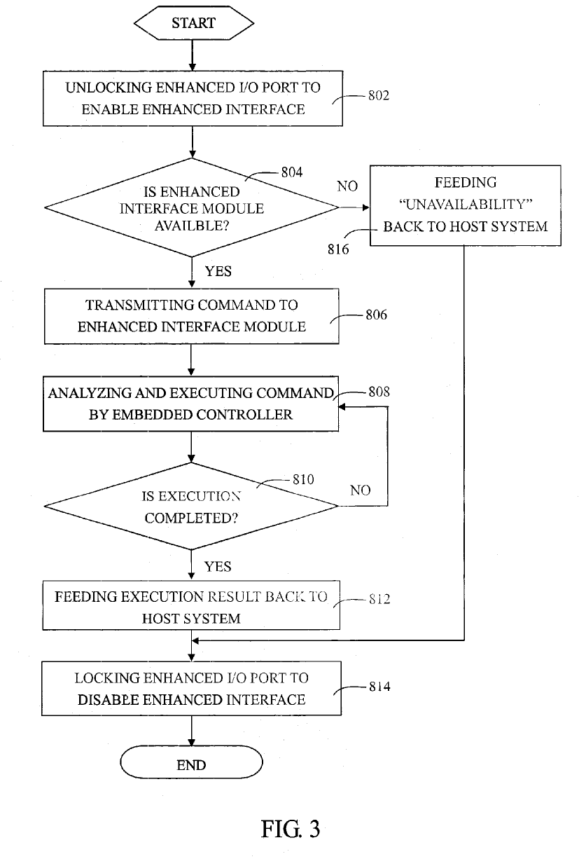

Referring to FIG. 3, an overall flow diagram of the computer system 100 is illustrated. When the extended command is to be transmitted, the working procedure of the computer system 100 is as follows:

802. Unlock the enhanced I/O port to enable the enhanced interface module 46.

804. Determine whether the enhanced interface controller 46 is available.

806. Transmit the extended command to the enhanced interface module 46, if the enhanced interface controller 46 is available.

808. Analyze the extended command and execute the corresponding application program.

810. Determine whether the execution is completed.

812. Feed back the execution result to the host system 102.

814. Lock the enhanced I/O port 110 to disable the enhanced interface module 46.

816. Feed an “unavailable” result back to the host system 102, if the enhanced interface controller 46 is not available.

The host system 102 sends an interrupt signal to enable the enhanced I/O port 110 (step 802). The embedded controller 104 determines whether the enhanced interface controller 46 is available (step 804). If the enhanced interface module 46 is unavailable, the “unavailable” result is fed back to the host system 102 (step 816), and the host system 102 then locks the enhanced I/O port 110 to disable the enhanced interface module 46 (step 814). Otherwise, if the enhanced interface module 46 is available, the host system 102 transmits the extended command to the enhanced interface module 46 via the enhanced I/O port 110 (step 806). The embedded controller 104 analyzes the extended command and executes the corresponding application program (step 808) as in steps 606, 608, and 610 in FIG. 2. During the execution, the embedded controller 104 determines whether the execution is completed (step 810). If the execution continues, step 808 repeats. If the execution completes, the execution result is fed back to the host system 102 via the enhanced I/O port 110 (step 812). After feedback, step 814 is implemented.

As described above, the computer system 100 utilizes the enhanced interface module 46 and the enhanced I/O port 110 thereof to separately transmits the extended commands to the embedded controller 46. As the standard ACPI compatible commands are transmitted via the KBC I/O port 106 or the EC I/O port 108 and the extended commands are transmitted via the enhanced I/O port 110, command disputes and interferences are sufficiently avoided. Efficiency of the entire computer system 100 is thus greatly increased. In addition, the private enhanced I/O port 110 is locked to improve the security once the enhanced interface module 46 is disabled.

It should be emphasized that the above-described embodiments of the present invention, including any preferred embodiments, are merely possible examples of implementation of the principles of the invention, and are merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and be protected by the following claims.

What is claimed is:

1. A computer system, comprising:
a host system with an input terminal;
an embedded controller including a keyboard controller module for controlling the input terminal of the host system, an embedded controller module for receiving standard embedded controller commands from the host system, and an enhanced interface module for receiving extended commands from the host system;
a keyboard controller I/O port configured to support communication between the host system and the keyboard controller module;
an embedded controller I/O port configured to support communication between the host system and the embedded controller module; and
an enhanced interface I/O port configured to support communication between the host system and the enhanced interface module.

2. The computer system as claimed in claim 1, wherein the enhanced interface module is a virtual interface module.

3. The computer system as claimed in claim 1, wherein the enhanced interface I/O port is a private port for communication between the host system and the enhanced interface module.

4. The computer system as claimed in claim 3, wherein the enhanced interface I/O port is used for transmitting the extended commands to the enhanced interface module.

5. The computer system as claimed in claim 4, wherein the enhanced interface I/O port is locked unless communication between the host system and the enhanced interface module is needed.

6. The computer system as claimed in claim 5, wherein the enhanced I/O port is addressed by 381H-383H.

7. A communication method for an embedded controller, the communication method comprising steps of:
receiving a command by an enhanced interface module of the embedded controller from a host system via an enhanced I/O port;
analyzing the command by the embedded controller;
invoking an application program corresponding to the command by the embedded controller; and executing the application program by the embedded controller.

8. The communication method as claimed in claim 7, wherein the enhanced I/O port is a private I/O port for the host system to access the enhanced interface module.

9. The communication method as claimed in claim 8, wherein the enhanced I/O port is addressed by 381H-383H.

10. The communication method as claimed in claim 7, wherein the command is an extended command.

11. The communication method as claimed in claim 7, further comprising a step of asserting a “busy” status flag of the enhanced interface module after the step of receiving.

12. The communication method as claimed in claim 11, further comprising a step of clearing the “busy” status flag of the enhanced I/O port after the step of feeding.

13. The communication method as claimed in claim 7, further comprising a step of feeding an execution result back to the host system.

14. A communication method between a host system and an embedded controller, the communication method comprising steps of:
transmitting an extended command from the host system to an enhanced interface module of the embedded controller via an enhanced interface I/O port; and
analyzing and executing the extended command by the embedded controller.

15. The communication method as claimed in claim 14, wherein the enhanced interface I/O port is addressed by 381H-383H.

16. The communication method as claimed in claim 14, wherein the enhanced interface module is a virtual module of the embedded controller.

17. The communication method as claimed in claim 14, further comprising a step of detecting whether the enhanced interface controller is available before the step of transmitting.

18. The communication method as claimed in claim 14, further comprises a step of locking the enhanced interface I/O port to disable the enhanced interface module.

19. The communication method as claimed in claim 18, further comprising a step of unlocking an enhanced interface I/O port to enable an enhanced interface module of the embedded controller.

20. The communication method as claimed in claim 14, further comprising a step of feeding an execution result back to the host system.
